(19) United States
(12) Patent Application Publication
(10) Pub. No.: US 2009/0213600 A1
(43) Pub. Date: Aug. 27, 2009

(54) Lighting device for motor vehicle

(75) Inventors: Stéphane Vanhelle, Marignier (FR); Patrice Laurent, Viuz en Sallaz (FR)

Correspondence Address: OSHA LIANG L.L.P., TWO HOUSTON CENTER, 909 FANNIN, SUITE 3500, HOUSTON, TX, 77010, US

(73) Assignee: DAV Societe Anonyme, Creteil (FR)

(21) Appl. No.: 11/663,609

(22) PCT Filed: Sep. 5, 2005
(86) PCT No.: PCT/EP05/54356

§ 371 Date: Mar. 22, 2007

(30) Foreign Application Priority Data
Sep. 22, 2004 (FR) 0410006

(51) Int. Cl. B60Q 1/00

(52) U.S. Cl. 362/464

(57) ABSTRACT

The invention concerns a lighting device (10) for motor vehicle comprising means (12) for ambient lighting of the vehicle passenger compartment. It comprises means (14) for measuring brightness, and means (16) for automatically controlling the ambient lighting means (12) based on the measured brightness.

The present invention relates to a lighting device for motor vehicles.

The human eye does not adjust immediately to an abrupt change in brightness. Thus, a person is momentarily dazzled when he moves abruptly from a dark environment to a well-lit environment. Conversely, a person momentarily sees only black when moving abruptly from a well-lit environment to a dark environment. The time it takes for the human eye to adjust is generally longer when moving from light to dark than in the opposite case. Normally, a person takes 20 to 30 minutes to become fully adjusted to the dark.

A motor vehicle driver can be subject to abrupt changes in brightness, for example when the vehicle moves into a tunnel. Because of this, the driver can be hindered on entering and leaving the tunnel, particularly when the sunlight is very bright outside the tunnel. In practice, the driver sees only black when entering the tunnel and is dazzled on leaving the tunnel.

In the state of the art, a lighting device for motor vehicles is already known, of the type comprising ambient lighting means for the interior of a vehicle passenger compartment.

These ambient lighting means are activated by manual control. They are intended to emit, normally at night, a comfort light inside the passenger compartment. This light is emitted outside the field of vision of the driver in order not to hinder him.

The main aim of the invention is to optimize the visual comfort of a driver, in particular by facilitating his adjustment to the abrupt changes in brightness.

To this end, the subject of the invention is a lighting device for motor vehicles, of the type comprising ambient lighting means for the interior of a vehicle passenger compartment, characterized in that it comprises:

means of measuring brightness, and

means of automatically controlling the ambient lighting means based on the measured brightness.

The brightness measuring means make it possible in particular to detect a consequential and rapid variation in this brightness (outside or inside the passenger compartment) and control the ambient lighting means accordingly. Thus, when the vehicle enters into a tunnel, the ambient lighting means are activated so as to limit the variation of brightness inside the passenger compartment, which limits the hindrance to the driver.

A lighting device for motor vehicles according to the invention can also comprise one or more of the following characteristics:

the control means activate the ambient lighting means when the measured brightness is less than a predetermined threshold;

the control means comprise means of processing the measured brightness, making it possible to determine a control parameter for the lighting means based on a variation in the measured brightness;

the control means comprise means of adjusting a light intensity of a light emitted by the lighting means;

the adjustment means comprise means that automatically vary the light intensity of the lighting means between a first maximum value and a second value less than or equal to the first, the value of the light intensity of the lighting means being maximum at the start of a lighting period;

the adjustment means comprise timer means imposing a predetermined transition time for the light intensity of the lighting means between the first and second values;

the device comprises means of memorizing the second light intensity value;

the device comprises means of determining the second light intensity value based on the measured brightness;

the device comprises means of adjusting a wavelength of a light emitted by the lighting means;

the device comprises means of controlling means of lighting the exterior of the vehicle based on the measured brightness;

the brightness measuring means are intended to measure a brightness outside the vehicle;

the brightness measuring means comprise means of detecting the, presence of a tunnel in front of a vehicle, for example first and second brightness sensors having, respectively, a detection field directed in front of the vehicle and a detection field directed upward.

The invention will be better understood from reading the description that follows, given purely by way of example and with reference to the appended drawings in which:

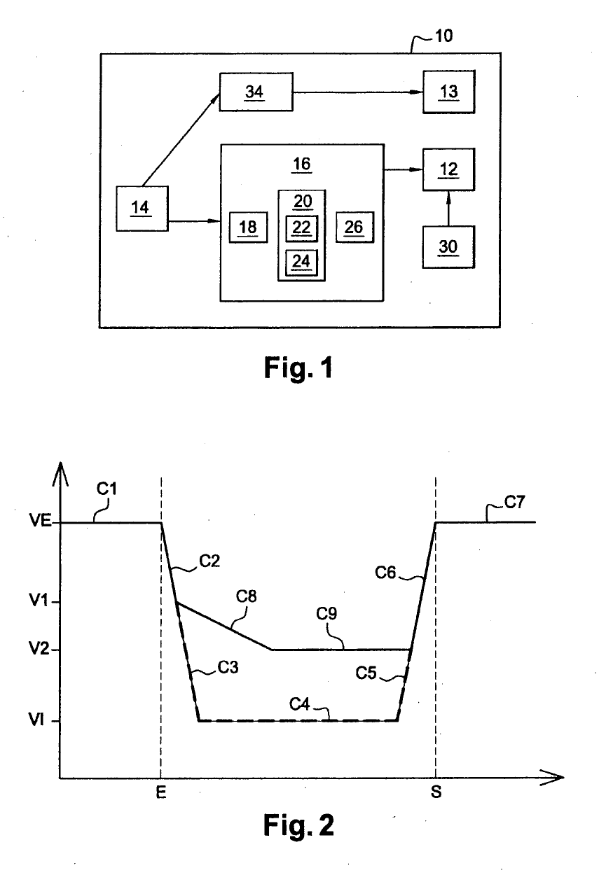

FIG. 1 is a diagram of a motor vehicle lighting device according to one embodiment of the invention;

FIG. 2 represents two curves showing the trend of the brightness or light intensity inside a passenger compartment of the motor vehicle, respectively with and without the lighting device of FIG. 1.

FIG. 1 diagrammatically represents a lighting device 10 for a motor vehicle.

This lighting device 10 comprises conventional ambient lighting means 12 for the interior of a motor vehicle passenger compartment, and conventional lighting means 13 for the exterior of the vehicle. The driver must normally activate these external lighting means 13 when the brightness outside the vehicle is weak.

It will be noted that the ambient lighting means 12 are intended to diffuse inside the passenger compartment, in certain situations, a light, normally subdued, for the visual comfort of the occupants of the vehicle, in particular the passengers. The ambient lighting means 12 are positioned outside the field of vision of the driver in order not to bother him.

The ambient lighting means 12 are controlled based on abrupt variations in brightness such as, for example, the brightness variations that occur when the motor vehicle moves into a tunnel.

To this end, the lighting device 10 comprises means 14 of measuring a brightness and means 16 of controlling the ambient lighting means 12 based on the brightness measured by the means 14.

Preferably, the brightness measuring means 14 comprise a sunlight sensor, a photodiode for example, that can measure the brightness outside the vehicle. As a variant, the brightness measuring means 14 can comprise a brightness sensor inside the vehicle.

The control means 16 comprise means 18 of processing the outside brightness measured by the means 14. Normally, the processing means 18 are used to determine a control parameter for the lighting means 12 based on a variation in the measured brightness.

Thus, the control means 16 can activate the lighting means 12 only when the brightness abruptly falls below a predetermined threshold, for example when the vehicle enters into a tunnel.

As a variant, the control means 16 can activate the ambient lighting means 12 when the outside brightness is below a predetermined threshold.

The control means 16 also comprise means 20 of adjusting the brightness of the light emitted by the lighting means 12 in order for this brightness to be able to change in accordance with a sequence optimized to favor the adjustment of the eye to a change in brightness inside the passenger compartment.

The adjustment means 20 preferably comprise means 22 that automatically vary the brightness of the lighting means 12 between a first maximum value V1 and a second value V2, less than or equal to the first value V1. Preferably, the value of the brightness of the lighting means 12 is maximum (that is, V1) at the start of a lighting period (the lighting period is triggered by an abrupt drop in outside brightness), in order to limit the drop in brightness inside the passenger compartment at the start of a period of activation of the ambient lighting.

Where appropriate, the adjustment means 20 comprise timer means 24 imposing a predetermined transition time for the brightness of the lighting means 12 between the first V1 and second V2 values.

The second brightness value V2 is normally predetermined. In this case, the control means 16 comprise means 26 of memorizing the second value V2. This second value V2 is normally that used for night-time ambient lighting.

As a variant, the second brightness value V2 can be determined based on the outside brightness measured by the measuring means 14.

The lighting device 10 preferably comprises means 30 of adjusting a wavelength of the light emitted by the lighting means 12. Thus, the color of the light emitted by the lighting means 12 can be adjusted, for example by a control manually actuated by the driver.

The lighting device 10 also preferably comprises means 34 of controlling the exterior lighting means 13 based on the outside brightness measured by the means 14.

In one embodiment that is not shown, the control means 16 for the interior lighting means 12 can be used to control the exterior lighting-means 13.

FIG. 2 shows two curves representing the trend of the brightness or light intensity (Y axis) in a vehicle passenger compartment when this vehicle passes through a tunnel (tunnel entry E and exit S on the X axis).

The first curve has portions C1, C2, C3, C4, C5, C6 and C7 representing the brightness inside the passenger compartment of a motor vehicle that does not have a lighting device 10 according to the invention.

The portion C1 corresponds to the motor vehicle moving outside the tunnel, for example in full daylight. The brightness inside the passenger compartment, denoted VE in the drawing, roughly corresponds to the outside brightness.

The end of the portion C1 corresponds to the vehicle entering into the tunnel at E. The brightness then drops (portions C2 and C3) to a value, denoted V1 in the drawing, corresponding to the brightness inside the passenger compartment when the vehicle is inside the tunnel.

The portion C4 corresponds to the vehicle moving inside the tunnel.

The end of the portion C4 corresponds to the vehicle approaching the exit of the tunnel. The brightness increases little by little (portions C5 and C6) until it reaches the value VE on exiting S the tunnel.

The second curve has portions C1, C2, C6 and C7, and portions C8 and C9 representing the brightness inside the passenger compartment of a motor vehicle equipped with the lighting device 10 according to the invention.

When the vehicle enters into a tunnel at E, the measuring means 14 detect a drop in the outside brightness.

When this outside brightness is below a predetermined threshold, or when the variation measuring means 18 detect a variation greater than a predetermined threshold, the control means 16 order the lighting means 12 to be switched on.

The brightness inside the passenger compartment of the motor vehicle does not then drop below the value V1 (the vehicle enters into the tunnel) corresponding to the maximum value of the brightness of the lighting means 12. It will be noted that thus, the eye of the driver is not subjected to a drop in brightness that is as abrupt as in the preceding case (without the lighting device according to the invention).

In the curve portion C8, the brightness of the lighting means 12 gradually diminishes from the value V1 to the value V2, over a predetermined time imposed by the timer means 26.

This brightness V2 remains roughly constant inside the passenger compartment while the vehicle moves inside the tunnel (curve portion C9).

When the vehicle approaches the exit S of the tunnel, the brightness increases little by little (portions C6) until it reaches the value VE on exiting the tunnel (portion C7). The brightness measuring means 14 once again detect a strong brightness and the control means 16 order the lighting means 12 to be switched off.

It will be noted that, with the invention, the eye of the driver is not subjected to an excessive change in brightness either on entering or on exiting the tunnel.

According to a refined variant, the brightness measuring means 14 are adapted to detect in advance the presence of a tunnel in front of the vehicle. The brightness measuring means 14 then perform an additional tunnel presence detection function.

In this case, the brightness measuring means 14 comprise first and second brightness sensors, having, respectively, a detection field directed in front of the vehicle and a detection field directed upward. The presence of a tunnel is thus detected when the first brightness sensor detects a significant drop in the brightness that it is measuring, below a predetermined threshold while the brightness measured by the second sensor remains constant.

Brightness measuring means 14 of this type make it possible to anticipate the control of the lighting means 12 and thus further enhance the visual comfort of the driver when the vehicle moves into a tunnel.

1. A lighting device for motor vehicles, of the type comprising ambient lighting means for the interior of a vehicle passenger compartment, wherein the lighting device comprises:
means of measuring brightness, and
means of automatically controlling the ambient lighting means based on the measured brightness,
in that the control means are designed to activate the ambient lighting means based on the measured brightness,
and in that the control means comprise means of adjusting a light intensity of a light emitted by the lighting means, the adjustment means comprising means that automatically vary the light intensity of the lighting means between a first maximum value (V1) and a second value (V2) less than or equal to the first, the value of the light intensity of the lighting means being maximum when the ambient lighting means are activated.

2. The lighting device as claimed in claim 1, wherein the control means activate the ambient lighting means when the measured brightness is less than a predetermined threshold.

3. The lighting device as claimed in claim 1, wherein the control means comprise means of processing the measured brightness, making it possible to determine a control parameter for the lighting means based on a variation in the measured brightness.

4. The lighting device as claimed in claim 1, wherein the adjustment means comprise timer means imposing a predetermined transition time for the light intensity of the lighting means between the first (V1) and second (V2) values.

5. The lighting device as claimed in claim 1, wherein the lighting device comprises means of memorizing the second light intensity value (V2).

6. The lighting device as claimed in claim 1, wherein the lighting device comprises means of determining the second light intensity value (V2) based on the measured brightness.

7. The lighting device as claimed in claim 1, wherein the lighting device comprises means of adjusting a wavelength of a light emitted by the lighting means.

8. The lighting device as claimed in claim 1, wherein the lighting device comprises means of controlling means of lighting the exterior of the vehicle based on the measured brightness.

9. The lighting device as claimed in claim 1, wherein the brightness measuring means are intended to measure a brightness outside the vehicle.

10. The lighting device as claimed in claim 9, wherein the brightness measuring means comprise means of detecting the presence of a tunnel in front of a vehicle, for example first and second brightness sensors having, respectively, a detection field directed in front of the vehicle and a detection field directed upward.

11. The lighting device as claimed in claim 2, wherein the control means comprise means of processing the measured brightness, making it possible to determine a control parameter for the lighting means based on a variation in the measured brightness.

12. The lighting device as claimed in claim 2, wherein the adjustment means comprise timer means imposing a predetermined transition time for the light intensity of the lighting means between the first (V1) and second (V2) values.

13. The lighting device as claimed in claim 3, wherein the adjustment means comprise timer means imposing a predetermined transition time for the light intensity of the lighting means between the first (V1) and second (V2) values.

14. The lighting device as claimed in claim 2, wherein the lighting device comprises means of memorizing the second light intensity value (V2).

15. The lighting device as claimed in claim 3, wherein the lighting device comprises means of memorizing the second light intensity value (V2).

16. The lighting device as claimed in claim 4, wherein the lighting device comprises means of memorizing the second light intensity value (V2).

17. The lighting device as claimed in claim 2, wherein the lighting device comprises means of determining the second light intensity value (V2) based on the measured brightness.

18. The lighting device as claimed in claim 3, wherein the lighting device comprises means of determining the second light intensity value (V2) based on the measured brightness.

19. The lighting device as claimed in claim 4, wherein the lighting device comprises means of determining the second light intensity value (V2) based on the measured brightness.
